(19) United States
(12) Patent Application Publication
(10) Pub. No.: US 2017/0158380 A1
(43) Pub. Date: Jun. 8, 2017

(54) RECLOSABLE BAG AND METHOD TO MAKE SAME

(71) Applicant: Poly-America, L.P., Grand Prairie, TX (US)

(72) Inventor: Michael A. Ross, West Lake, TX (US)

(21) Appl. No.: 14/956,628

(22) Filed: Dec. 2, 2015

(51) Int. Cl. B65D 33/24; B65D 33/08; B31B 37/00; B65D 30/20

(52) U.S. Cl. CPC B65D 33/24; B65D 31/10; B65D 33/08; B31B 37/00; B31B 2237/20; B31B 2219/909; B31B 2219/9016

(57) ABSTRACT

The present invention relates to improvements for shopping and merchandise bags with integral handles. Disclosed is a bag with integral handles and closure elements located below the integral handles. The disclosed bag provides a cost effective solution for a reclosable bag with integral handles. Further disclosed is a process for manufacturing a reclosable bag with integral handles.

### CROSS-REFERENCE TO RELATED APPLICATIONS

Not applicable.

### BACKGROUND OF THE INVENTION

1. Field of the Invention

The present invention relates to an improved merchandise or shopping bag with an integral handle and reclosable feature. Particularly, the present invention relates to a bag with integral handles which includes a closure mechanism with male and female closure elements that is adapted for high speed and cost effective manufacturing.

2. Description of the Related Art

Thermoplastic films are used in a variety of applications. For example, thermoplastic films are used in sheet form for applications such as drop cloths, vapor barriers, and protective covers. Thermoplastic films can also be converted into plastic bags, which may be used in a myriad of applications. The present invention is particularly useful for bags constructed from thermoplastic film.

Polymeric bags are ubiquitous in modern society and are available in countless combinations of varying capacities, thicknesses, dimensions, and colors. The bags are available for numerous applications including typical consumer applications such as long-term storage, food storage, shopping, and trash collection. Like many other consumer products, increased demand and new technology have driven innovations in polymeric bags improving the utility and performance of such bags. The present invention is an innovation of particular relevance to food storage bags.

Polymeric bags are manufactured from polymeric film produced using one of several manufacturing techniques well-known in the art. The two most common methods for manufacture of polymeric films are blown-film extrusion and cast-film extrusion. In blown-film extrusion, the resulting film is tubular while cast-film extrusion produces a generally planar film. The present invention is generally applicable to bags manufactured from a blown-film extrusion process resulting in tubular film stock.

In blown film extrusion, polymeric resin is fed into an extruder where an extrusion screw pushes the resin through the extruder. The extrusion screw compresses the resin, heating the resin into a molten state under high pressure. The molten, pressurized resin is fed through a blown film extrusion die having an annular opening. As the molten material is pushed into and through the extrusion die, a polymeric film tube emerges from the outlet of the extrusion die.

The polymeric film tube is blown or expanded to a larger diameter by providing a volume of air within the interior of the polymeric film tube. The combination of the volume of air and the polymeric film tube is commonly referred to as a bubble between the extrusion die and a set of nip rollers. As the polymeric film tube cools travelling upward toward the nip rollers, the polymeric film tube solidifies from a molten state to a solid state after it expands to its final diameter and thickness. Once the polymeric film tube is completely solidified, it passes through the set of nip rollers and is collapsed into a collapsed polymeric tube, also referred to as a collapsed bubble.

One common method of manufacturing polymeric bags involves segregating the collapsed polymeric tube into individual trash bags by forming seals which extend transversely across the entire width of the tube with each seal forming the bottom of a bag. Typically, a line of perforations is formed immediately adjacent and parallel to each seal to facilitate separation of the trash bags one from another. The opening of the perforations then forms the top of a bag and opposing edges of the collapsed polymeric tube then form the opposing sides of a bag.

It is known to provide wave-cut bags by a continuous multi-bag manufacturing process from a collapsed bubble or tube. The collapsed bubble may be slit through both a front and back of the bubble with a repeating waveform pattern. Repeating evenly spaced pairs of transverse heat seals may be placed on both halves of the slit bubble to define left and right side edges of each bag. In between each pair of heat seals a perforation or cut line may be placed so that the formed bags may be separated. The slit middle of the collapsed bubble forms the top of the bag and one of the two opposing edges of the collapsed bubble forms the bottom of the bag.

The lobe-shaped features, or lobes, of wave-cut bags can have holes punched out or otherwise provided in the middle of the lobe to provide a convenient handle for the user to carry the bag. Unfortunately, if only a single lobe is provided on each side of the bag it is difficult to close the bag and if the lobes are used to tie the bag then the lobes no longer function as handles since their length is taken up in a knot. Hence, it would be useful to provide a cost-effective means to close the bag while still maintaining use of the bag's handles. Providing a means to reclose the bag also allows the bag to be repurposed as a storage bag after being used as a merchandise or shopping bag.

U.S. Pat. No. 4,125,220 (the '220 patent), hereby incorporated by reference into this disclosure, discloses a wave-cut shopping bag with a sinusoid waveform defining a top handle of the shopping bag. A width of the bag is disclosed as equal to a single wavelength with a hole or handle opening centered vertically on the base line of the wavelength and centered horizontally at the peak of the waveform. The '220 patent, however, fails to disclose any convenient means to close the bag.

Reclosable plastic bags are well-known in the art and are available in a variety of different sizes and configurations. Most commonly, reclosable plastic bags have one or more pairs of opposing, interlocking closures near the top opening of the reclosable bag. The closure may generally be opened and closed many times and are typically designed to ensure that the contents of the reclosable plastic bag are securely contained within the bag when the opposing closures are mutually engaged.

The closures of reclosable bags can be opened and closed in a number of different ways. For example, a slider or zipper device can be incorporated into the bag design to facilitate engagement and disengagement of the opposing closures. However, many reclosable bags have closures that are designed to be opened by physically pulling the closures apart and closed by pressing the closures together along the length of the closure.

U.S. Pat. No. 3,402,749 (the '749 patent), hereby incorporated by reference into this disclosure, discloses a plastic film shopping bag with a reclosable zipper device and hand holes formed in integral flanges above the reclosable zipper device. However, the '749 patent relies upon straight cut upper flanges for handles which provides a difficult to grasp handle and fails to efficiently utilize material for forming the bag and its corresponding handles.

In consideration of the shortcomings of the above discussed prior art, it would be desirable to provide a merchandise or shopping bag having an integral handle and a reclosable opening. It would further be desirable to provide such a bag that takes advantage of high speed manufacturing processes and efficiently utilizes material. The present invention represents a novel solution to address these needs.

### SUMMARY OF THE INVENTION

According to one embodiment of the present invention, a bag is formed from a collapsed tube of polymeric film. The bag may comprise a first panel and a second panel. The first panel and the second panel may be joined at a first side edge by a first side seal, at a second side edge by a second side seal, and at a bottom edge. The bottom edge may be defined by a first edge of the collapsed tube. The first panel may have a first top edge opposite the bottom edge and the second panel may likewise have a second top edge opposite the bottom edge. The first top edge and second top edge may define an opening of the bag. The first top edge and the second top edge may have a wave-shaped profile and the wave-shaped profile may define a lobe in the first panel and a lobe in the second panel. A first closure element may be disposed on an interior of the first panel and extend generally from the first side edge to the second side edge. The first closure element may be located below the wave-shaped profile of the first top edge. A second closure element may be disposed on an interior of the second panel opposite from the first closure element and extend generally from the first side edge to the second side edge. The second closure element may be located below the wave-shaped profile of the second top edge.

In certain embodiments of the present invention, a peak of the wave-shaped profile of both the first top edge and second top edge may be located generally equidistant from the first side edge and the second side edge. A circular opening may be defined centrally within each lobe of the first and second panels. The circular opening may be located equidistant from the first side edge and the second side edge. A gusset may also be defined within the bottom edge of the bag. The first and second closure elements may comprise male and female closure elements and the first and second closure elements may be affixed to the first and second panels by one or more heat seals. In an alternative embodiment, the first and second closure elements may be affixed to the first and second panels by a pressure sensitive adhesive.

In a further embodiment of the present invention, a polymeric bag may be formed by a process from a continuous polymeric film tube. The polymeric film tube may be collapsed to form a collapsed tube. Prior to collapsing the polymeric film tube, a gusset may be formed within a first side and an opposing second side of the polymeric film tube. The collapsed tube may have front and rear sections, opposing first and second folded edges, and a machine direction. The collapsed tube may be slit in a repeating waveform through the front and rear sections of the collapsed tube in the machine direction. The slitting of the collapsed tube may result in a plurality of lobes with the waveform centered between the first and second folded edges. A central opening may be formed within each of the plurality of lobes. The slitting may further result in first and second tube sections with the first and second tube sections having front and rear sections. A distal end of the front section of the first tube section may be separated from a distal end of the rear section of the first tube section. A first closure element may be affixed to an interior of the front section of the first tube section with the first closure element extending generally in the machine direction. A second closure element may be affixed to an interior of the rear section of the first tube section with the second closure element also extending generally in the machine direction. The first tube section may then be formed into a plurality of bags.

The plurality of bags may be formed by sets of closely spaced, parallel seals that extend transversely across a width of the first tube section. Perforations may also be formed that extend transversely across the width of the first tube section with a perforation between and parallel with each set of parallel seals. Each waveform may have a plurality of peaks and bases with each set of parallel seals centered at each base so that each peak of the waveform is centered in the machine direction between sets of parallel seals. In an alternate preferred embodiment, a plurality of side seals may be formed with each side seal extending transversely across a width of the first tube section at each base of the wave-shape profile. Simultaneously with the formation of each side seal, the first tube section may be cut through about or within each side seal.

In at least one embodiment, the first closure element may be affixed to the front section of the first tube section with one or more heat seals and the second closure element may be affixed to the rear section of the first tube section with one or more heat seals. In an alternative embodiment, the first closure element may be affixed to the front section of the first tube section with a pressure sensitive adhesive and the second closure element may likewise be affixed to the rear section of the first tube section with a pressure sensitive adhesive. The first and second closure elements may be comprised of male and female closure elements. The first and second closure elements may also be comprised of interlocking press to close closure elements. Additionally, the first closure element may be interlocked with the second closure element.

It is contemplated that the present invention may be utilized in ways that are not fully described or set forth herein. The present invention is intended to encompass these additional uses to the extent such uses are not contradicted by the appended claims. Therefore, the present invention should be given the broadest reasonable interpretation in view of the present disclosure, the accompanying figures, and the appended claims.

### BRIEF DESCRIPTION OF THE RELATED DRAWINGS

A full and complete understanding of the present invention may be obtained by reference to the detailed description of the present invention and the preferred embodiments when viewed with reference to the accompanying drawings. The drawings can be briefly described as follows.

FIG. 1 provides a perspective view of a reclosable bag as contemplated by one embodiment of the present invention.

FIG. 2 provides a front view of the reclosable bag of the embodiment of FIG. 1.

FIG. 3 provides a top view of a collapsed polymeric tube utilized in a method to form the bag of FIGS. 1 and 2.

FIG. 4 provides a cross-sectional view of the collapsed polymeric tube of FIG. 3 taken along line A-A with the material thickness exaggerated for purposes of clarity.

FIG. 5 provides a side view of a manufacturing apparatus according to the method to form the bag of FIGS. 1 and 2 with a first tube section of the collapsed polymeric tube of FIG. 3 shown in cross-section.

FIG. 6a provides a top view of the first tube section of the collapsed polymeric tube of FIG. 3.

FIG. 6b provides another top view of an alternative embodiment of the first tube section of FIG. 3.

### DETAILED DESCRIPTION OF THE INVENTION

The present disclosure illustrates one or more preferred embodiments of the present invention. It is not intended to provide an illustration or encompass all embodiments contemplated by the present invention. In view of the disclosure of the present invention contained herein, a person having ordinary skill in the art will recognize that innumerable modifications and insubstantial changes may be incorporated or otherwise included within the present invention without diverging from the spirit of the invention. Therefore, it is understood that the present invention is not limited to those embodiments disclosed herein. The appended claims are intended to more fully and accurately encompass the invention to the fullest extent possible, but it is fully appreciated that certain limitations on the use of particular terms is not intended to conclusively limit the scope of protection.

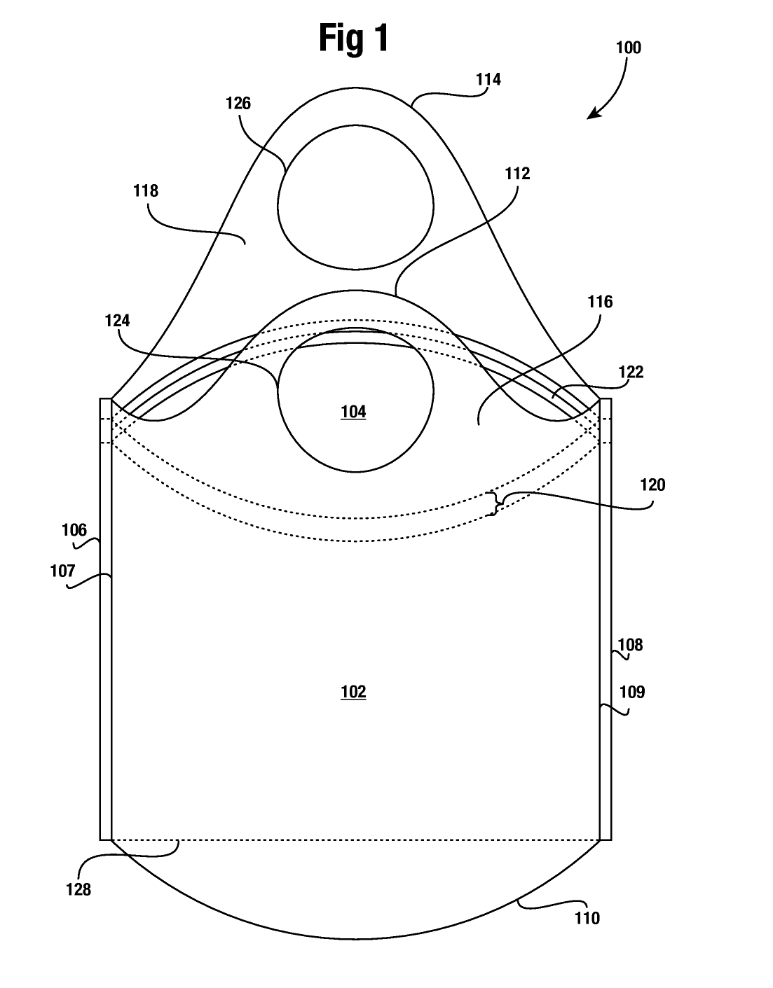

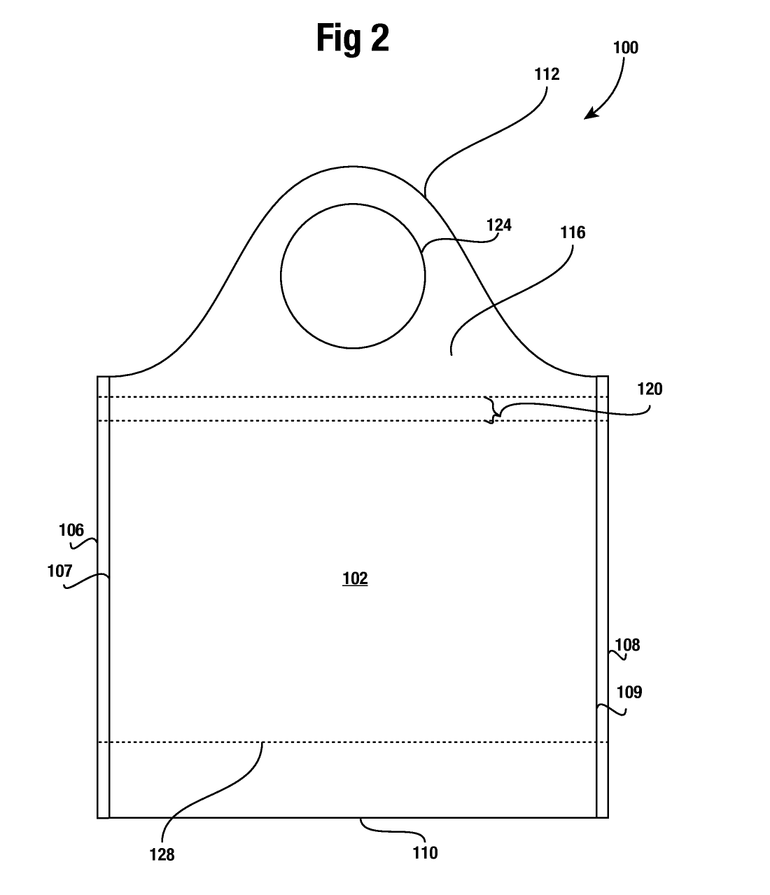

FIGS. 1 and 2 depict a reclosable shopping or merchandise bag 100. The bag 100 is shown having a first panel 102 and a second panel 104. The two panels 102 and 104 are joined together at a first side 106 by first seal 107, at a second side 108 by a second seal 109, and at a bottom edge 110. The first panel 102 and second panel 104 may be formed from a single piece of polymeric film which is folded to define the bottom edge 110. A first top edge 112 and second top edge 114 are shown defined at an upper distal end of the first panel 102 and the second panel 104 respectively. Each top edge 112 and 114 may be in the form of a wave-shaped profile to form lobe 116 and 118 in each bag panel 102 and 104. Lobe 116 and 118 each comprise one period of the wave-shaped profile such that a width of bag 100 from the first side 106 to the second side 108 is one wavelength of the wave-shaped profile. The wave-shaped profile may comprise a sinusoidal wave shape but other wave-shaped profiles are also contemplated by the invention.

As further shown in FIGS. 1 and 2, below top edges 112 and 114 are handle openings 124 and 126. The handle openings 124 and 126 are shown positioned vertically between a peak and base (i.e. lowest point) of the wave-shaped profile within each lobe 116 and 118. The handle openings 124 and 126 are further shown positioned horizontally midway between opposing bases of the wave-shaped profile. Due to the symmetry of bag 100, handle openings 124 and 126 are also shown equidistant from first and second sides 106 and 108. Also shown in FIGS. 1 and 2 is each opening 124 and 126 having a generally circular shape.

Looking again at FIGS. 1 and 2, a first closure element 120 is shown disposed on an interior surface of the first panel 102 and a second closure element 122 is shown disposed on an interior surface of the second panel 104. Both the first and second closure elements 120 and 122 are shown extending from the first side 106 to the second side 108 of bag 100. The first and second closure elements 120 and 122 may be configured to engage with each other for closing bag 100 below the closure elements 120 and 122. In a preferred embodiment, closure elements 120 and 122 may be affixed to bag 100 by one or more heat seals with each heat seal extending in a lengthwise direction of closure elements 120 and 122. In an alternative embodiment, closure elements 120 and 122 may be affixed to bag 100 by a pressure sensitive adhesive. Further shown in FIGS. 1 and 2 is a gusset 128 formed in a bottom portion of bag 100.

The dimensions of polymeric bag 100 may vary but in one particular embodiment a width of bag 100, from the first side edge 106 to the second side edge 108, may be about 10-14 inches. A height of bag 100 from bottom edge 100 to closure elements 120 and 122 may be about 8-14 inches. A height of each bag 100 handle from a base to a peak of the wave-shaped profile may be about 4-8 inches. A total of height of bag 100 from the bottom edge 110 to a peak of the wave-shaped profile may be about 12-20 inches. A thickness of the polymeric film of bag 100 may also vary but in particular embodiments may range from about 0.4 mils to 4 mils. The diameter of each handle opening 124 and 126 may also vary but in certain embodiments of bag 100 it may be about 2.5-5 inches.

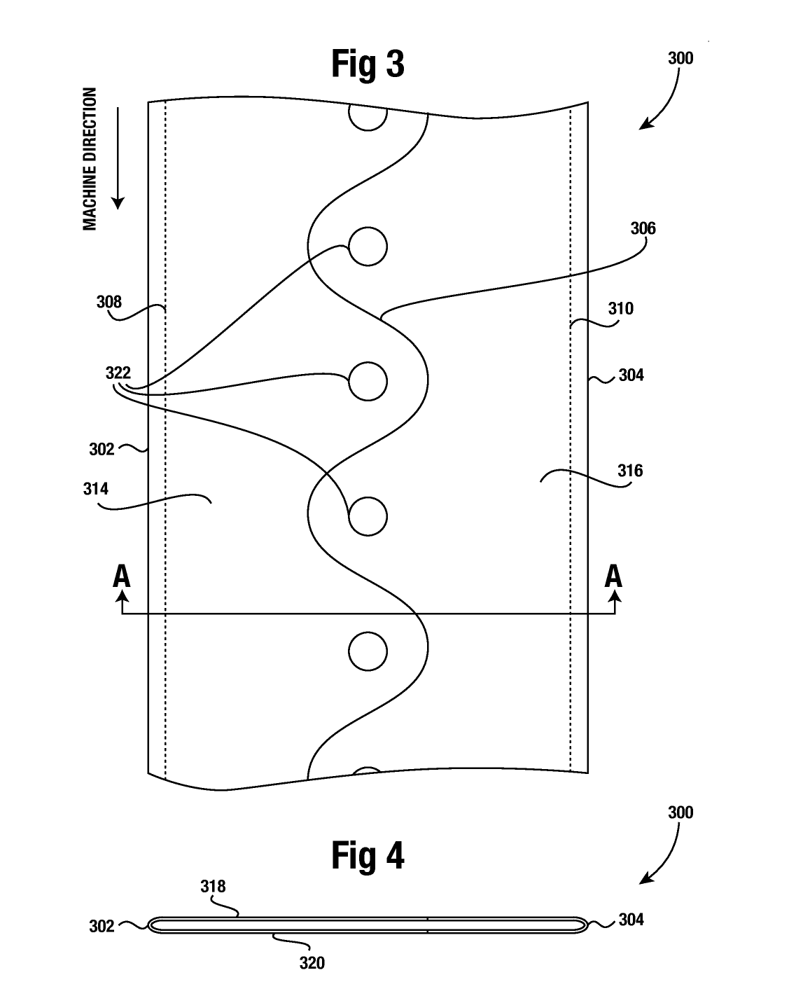

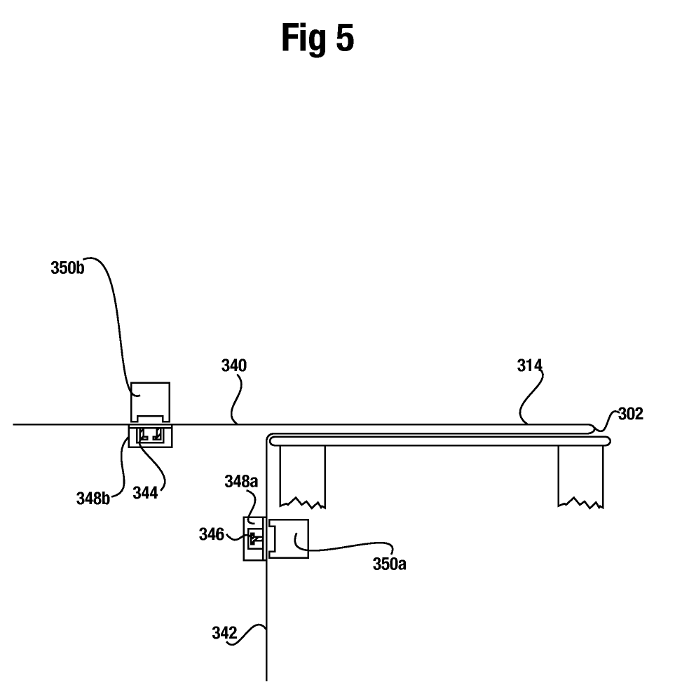

Shown in FIGS. 3 and 4 is a collapsed polymeric tube 300 utilized in a process for forming bag 100. Collapsed polymeric tube 300 may be formed from a polymeric film tube by a blown film extrusion process. As shown in FIG. 4, the collapsed polymeric tube comprises a front side 318 and a rear side 320. The collapsed polymeric tube 300 has a machine direction extending in the direction of extrusion which may also be referred to as a lengthwise direction of the polymeric film tube. The direction perpendicular to the machine direction of the polymeric film tube is commonly referred to as the cross-direction. Prior to the collapsing of the polymeric film tube, continuous gusset lines 308 and 310 may be formed in the polymeric film tube as shown in FIGS. 3 and 4, as is known in the art.

The polymeric resin used in the blown film extrusion process may vary. However, for forming polymeric bags, a polyethylene resin is commonly used. In the current state of the art for polymeric bags, a blend of various polyethylene polymers may be used. A polymer blend can have linear low-density polyethylene (LLDPE) or high-density polyethylene (HDPE) as the primary component. Other polymers may be utilized such as low-density polyethylene (LDPE). The polymer blend may include additives including, but not limited to, coloring additives, anti-blocking agents, and/or odor control additives. The film utilized to form polymeric bags may also comprise multiple layers of blown film resin. The resultant multi-layer film may be formed by co-extrusion, a lamination process, or other methods of forming a multi-layer film known in the art. In each layer, one or more of the above-discussed polymers may be used.

As further shown in FIGS. 3 and 4, once the polymeric film tube is collapsed, the collapsed tube 300 is longitudinally severed in the shape of a repeating waveform pattern 306 by a slitting operation. In at least one embodiment, as shown by FIGS. 3 and 4, the waveform 306 is sinusoidal. The slitting operation severs both the front side 318 and rear side 320 of the collapsed tube 300. The waveform 306 is shown centered between a first side edge 302 and a second side edge 304 of the collapsed tube 300 so that once severed, the collapsed tube is divided into two equal sections, a first tube section 314 and a second tube section 316 such that both sections have a repeating waveform pattern at an open top edge of each tube section 314 and 316.

Once the collapsed tube 300 is severed with waveform 306, circular openings 322 may be punched or otherwise formed in collapsed tube 300. In an alternative embodiment, circular openings 322 may be formed in collapsed tube 300 prior to the slitting operation. Each circular opening 322 is shown located about a centerline of collapsed tube 300 and also aligned in a machine direction of the collapsed tube at each peak of waveform 306. Once circular openings 322 are placed in the collapsed tube 300, first and second tube sections 314 and 316 may be separated from each other for further conversion into polymeric bags.

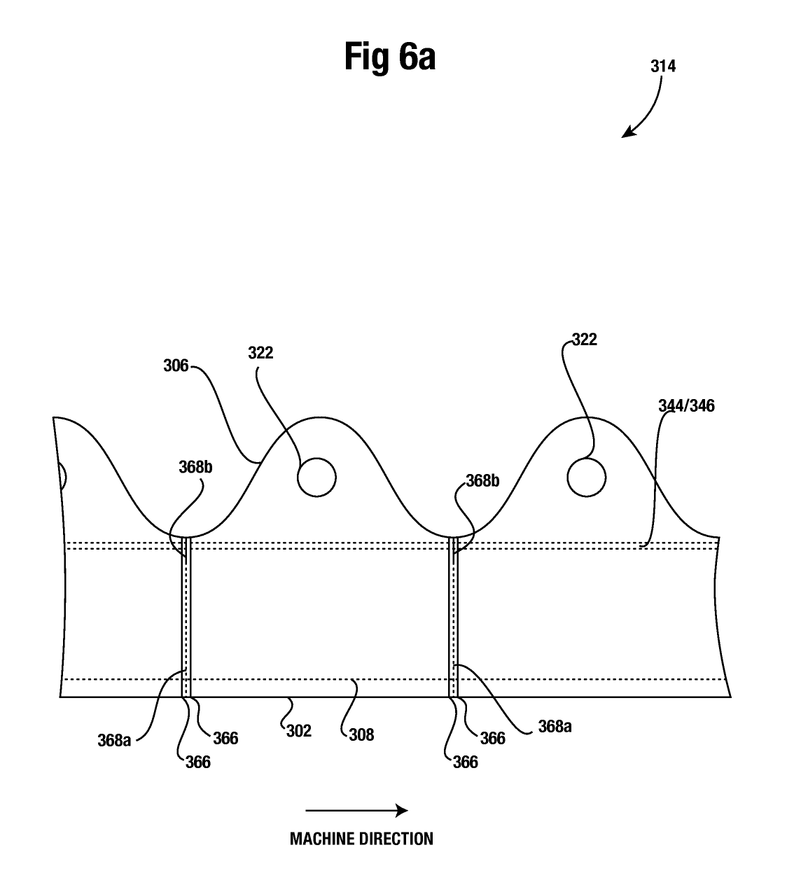

Shown in FIG. 5 is a cross-section of first tube section 314 which comprises front section 340 and rear section 342. Second tube section 316 may be manufactured in a likewise manner as first tube section 314 and hence is not discussed further. As shown by FIG. 5, first tube section 314 may be partially open by a bag converting process so that distal edges of front section 340 and rear section 342 are separated from each other. Once the distal edges of front and rear sections 340 and 342 are separated, first and second continuous closure elements 344 and 346 may be placed on interior surfaces of front and rear sections 340 and 342 of first tube section 314. Closure application guides 348a and 348b may be used to place continuous closure elements 344 and 346 onto front and rear sections 340 and 342 of first tube section 314.

As further shown in FIG. 5, once continuous closure elements 344 and 346 are placed on front and rear sections 340 and 342 of the first tube section 314, sealing mechanisms 350a and 350b may seal the continuous closure elements onto the front and rear sections 340 and 342. In at least one preferred embodiment, continuous closure elements 344 and 346 may be sealed onto the front and rear sections 340 and 342 by heat sealing. In another alternative embodiment, continuous closure elements 344 and 346 may be affixed to front and rear sections 340 and 342 with a pressure sensitive adhesive. Once continuous closure elements 344 and 346 are affixed to the first tube section 314, the distal edges of front and rear sections 340 and 342 may be brought back towards each other and closure elements 344 and 346 may be mutually engaged so that bag first tube section 314 is fully closed.

Continuous closure elements 344 and 346 may be press and close type closure elements with one of the closure elements a female closure element and the other of the closure elements a male closure element as is known in the art. One particular example of female and male closure elements is disclosed in United States Pat. Appl. Publ. No. US2011/0311167A1 (the '167 publication) which is hereby incorporated by reference. FIG. 2 of the '167 publication discloses a first male closure element 200 and a first female closure element 220. Another example of male and female closure elements also shown in FIG. 2 of the '167 publication are second male closure element 240 and second female closure element 260. In one particular embodiment of the present invention, it may be desirable for continuous closure elements 344 and 346 to be similar to the second male and female closure elements 240 and 260 of the '167 publication since the asymmetric shape of the male closure element 240 provides for a higher interior opening force in comparison to an exterior opening force, as explained in the '167 publication.

In one particular embodiment of the present invention, continuous closure elements 344 and 346 may be manufactured separately from the collapsed tube 300 and provided as roll stock, or in other various bulk forms, for application to each tube section 314 and 316. In an alternative embodiment, continuous closure elements 344 and 346 may be manufactured in-line with the contemplated manufacturing process of the present invention and formed in-line prior to application to each tube section 314 and 316.

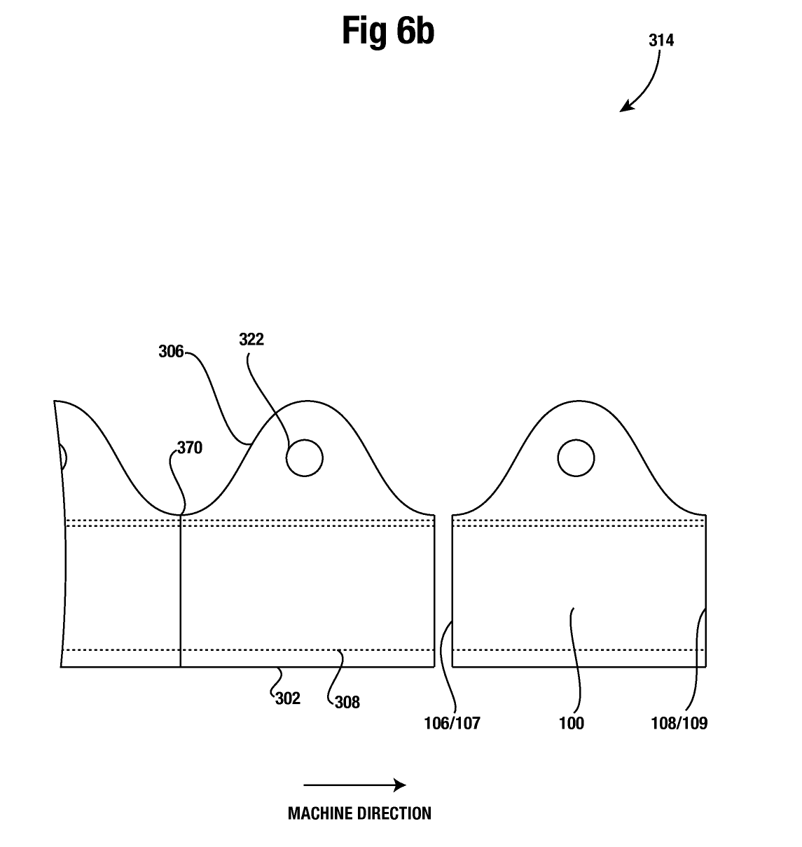

Shown in FIG. 6a is first tube section 314 with continuous closure elements 344 and 346 applied to front and rear sections 340 and 342 of the first tube section 314. Front and rear sections 340 and 342 are shown adjacent to each other and generally in the same plane. A plurality of closely spaced generally parallel sets of seals 366 are shown formed on the first tube section 314 by a bag converting process to form side seals for individual bags 100. Each set of seals 366 is shown placed at the base, i.e. the lowest points, of waveform 306 and extending in the cross-direction from the first side edge 302 to the upper edge waveform 306 of the first tube section 314.

As further shown in FIG. 6a, once the sets of seals 366 are formed, perforations 368a may be made in the first tube section 314 in between and parallel to each set of seals 366 to form individual bags 100. However, in at least one preferred embodiment, the first tube section 314 may be partially cut through with through-cut 368b. Through-cut 368b extends from waveform upper edge 306 to below continuous closure elements 344 and 346. Utilization of through-cut 368b in proximity to continuous closure elements 344 and 346 prevents continuous closure elements 344 and 346 from interfering with later separation of the perforation. The perforated tube section 314 may then be rolled for packaging or the perforated tube section 314 may further be separated into individual bags 100.

FIG. 6b illustrates an alternative embodiment from FIG. 6a of the process of forming first tube section 314 into individual bags 100. Rather than parallel seals and perforations, burn-through seal 370 is shown forming individual bags 100 from first tube section 314. Burn-through seal 370 is shown traversing first tube section 314 in the cross-direction at each base of wave-form profile 306 in place of the perforation 368 of the previous embodiment. Burn-through seals, or hot-knife edge seals, as known in the art, simultaneously seal adjoining layers of film together and cut through the layers—i.e. burn through. Thus, once burn-through seal 370 is applied to first tube section 314, first tube section 314 is separated into individual bags 100. Since burn-through seal 170 simultaneously seals and cuts, no closely spaced sets of seals 366 are necessary as described for the previous embodiment. The burn-through seal 370 forms opposing side seals such that first seal 107 is formed at first side 106 and second seal 109 is formed at second side 108 of bag 100 as shown in FIG. 6b. Once individual bags 100 are separated by burn-through seal 170, the bags may be stacked or otherwise arranged for packaging.

As previously noted, the specific embodiments depicted herein are not intended to limit the scope of the present invention. Indeed, it is contemplated that any number of different embodiments may be utilized without diverging from the spirit of the invention. Therefore, the appended claims are intended to more fully encompass the full scope of the present invention.

I claim:

1. A bag formed from a collapsed tube of polymeric film, the bag comprising:
a first panel and a second panel, the first panel and the second panel joined at a first side edge by a first side seal, at a second side edge by a second side seal, and at a bottom edge,
the bottom edge defined by a first edge of the collapsed tube,
the first panel having a first top edge opposite the bottom edge and the second panel having a second top edge opposite the bottom edge, the first top edge and second top edge defining an opening of the bag,
the first top edge and second top edge having a wave-shaped profile, the wave-shaped profile defining a lobe in each of the first and second panels,
a first closure element disposed on an interior of the first panel and extending generally from the first side edge to the second side edge, the first closure element located below the wave-shaped profile of the first top edge, and
a second closure element disposed on an interior of the second panel opposite from the first closure element and extending generally from the first side edge to the second side edge, the second closure element located below the wave-shape profile of the second top edge.

2. The bag of claim 1 further comprising:
a peak of the wave-shaped profile of both the first top edge and second top edge located generally equidistant from the first side edge and the second side edge.

3. The bag of claim 1 further comprising:
a circular opening defined centrally within each lobe of the first and second panels.

4. The bag of claim 3 further comprising:
the circular opening located equidistant from the first side edge and the second side edge.

5. The bag of claim 1 further comprising:
a gusset defined within the bottom edge of the bag.

6. The bag of claim 1 further comprising:
the first and second closure elements comprising a male and female closure elements.

7. The bag of claim 1 further comprising:
the first and second closure elements affixed to the first and second panels by one or more heat seals.

8. The bag of claim 1 further comprising:
the first and second closure elements affixed to the first and second panels by a pressure sensitive adhesive.

9. The bag of claim 6 further comprising:
the first and second closure elements comprising press to close closure elements.

10. A method of forming a bag from a polymeric film tube, the method comprising:
collapsing the polymeric film tube to form a collapsed tube, the collapsed tube having front and rear sections, opposing first and second folded edges, and a machine direction,
slitting a repeating waveform through the front and rear sections of the collapsed tube in the machine direction, the waveform centered between the first and second folded edges,
the slitting resulting in separate first and second tube sections of the collapsed tube,
the first and second tube sections having front and rear sections,
separating a distal end of the front section of the first tube section from a distal end of the rear section of the first tube section,
affixing a first closure element to an interior of the front section of the first tube section, the first closure element extending generally in the machine direction,
affixing a second closure element to an interior of the rear section of the first tube section, the first closure element extending generally in the machine direction, and
forming a plurality of bags from the first tube section.

11. The method of claim 10, the forming of the plurality of bags further comprising:
forming sets of closely spaced, parallel seals extending transversely across a width of the first tube section, and
forming perforations extending transversely across the width of the first tube section, a perforation generally parallel and between each set of parallel seals.

12. The method of claim 11 further comprising:
the slitting forming a plurality of peaks and bases of the repeating waveform, each set of parallel seals centered at each base resulting in a peak of the repeating waveform centered in the machine direction between a set of parallel seals.

13. The method of claim 10 further comprising:
forming a gusset within a first side and an opposing second side of the tube of polymeric film.

14. The method of claim 10 further comprising:
the slitting defining a plurality of lobes in the first tube section, and
forming a central opening within each of the plurality of lobes.

15. The method of claim 10 further comprising:
affixing the first closure element to the front section of the first tube section with one or more heat seals, and
affixing the second closure element to the rear section of the first tube section with one or more heat seals.

16. The method of claim 10 further comprising:
affixing the first closure element to the front section and the second closure element to the rear section of the first tube section with a pressure sensitive adhesive.

17. The method of claim 10 further comprising:
the first and second closure elements comprising male and female closure elements.

18. The method of claim 10 further comprising:
the first and second closure elements comprising interlocking press to close closure elements.

19. The method of claim 10 further comprising:
interlocking the first closure element with the second closure element.

20. The method of claim 10, the forming of the plurality of bags further comprising:
simultaneously forming a side seal extending transversely across a width of the first tube section at a base of the wave-shape profile and cutting transversely across the width of the first tube section at the base.
